(19) United States
(12) Patent Application Publication
(10) Pub. No.: US 2016/0286460 A1
(43) Pub. Date: Sep. 29, 2016

(54) DISPLAY CONTROL DEVICE AND DISPLAY CONTROL SYSTEM

(71) Applicant: Panasonic Intellectual Property Management Co., Ltd., Osaka (JP)

(72) Inventor: Hiroki SHINOHARA, Kanagawa (JP)

(73) Assignee: Panasonic Intellectual Property Management Co., Lt d., Osaka (JP)

(21) Appl. No.: 15/077,252

(22) Filed: Mar. 22, 2016

(30) Foreign Application Priority Data
Mar. 23, 2015 (JP) 2015-059016
Jan. 29, 2016 (JP) 2016-015009

(51) Int. Cl. H04W 40/24; H04L 29/08; G06F 3/147

(52) U.S. Cl. CPC H04W 40/244; G06F 3/147; H04L 67/125

(57) ABSTRACT

A display control device to be connected to a display device and a mobile terminal includes: a receiver that receives identification information containing terminal information for identifying the mobile terminal and area information for identifying an installation area of the display device; a storage unit that stores the identification information together with a transmission or reception date and time; and a transmitter that transmits first or second distribution information to the display device, based on the identification information. When a number of visits is smaller than a predetermined number and an interval between dates and times in a plurality of pieces of the identification information is longer than a predetermined interval or when a plurality of the installation areas are identical to one another and, the number of visits is one, the transmitter transmits the first distribution information, and otherwise, transmits the second distribution information.

### BACKGROUND

1. Technical Field

The present disclosure relates to a display control device and a display control system that update display used for, for example, digital signage.

2. Description of the Related Art

Some conventional digital signage distribution systems determine whether a user is a local person or a traveler, based on a user's address, and reflect this determination result in signage.

### CITATION LIST

### Patent Literature

PLT 1: Unexamined Japanese Patent Publication No. 2013-161360

However, direct use of users' addresses may be problematic in terms of privacy.

### SUMMARY

An object of the present disclosure is to efficiently provide information suitable for users with their privacy ensured.

A display control device according to an aspect of the present disclosure is a display control device to be connected to a display device and a mobile terminal, and includes: a receiver that receives identification information containing terminal, information for identifying the mobile terminal and area information for identifying an installation area of the display device; a storage unit that stores the identification information together with a transmission date and time or a reception date and time and a transmitter that transmits first distribution information or second distribution information to the display device, based on the identification information. When a number of visits is smaller than a predetermined number and an interval between dates and times in a plurality of pieces of the identification information is longer than a predetermined interval or when a plurality of the installation areas are identical to one another and the number of visits is one, the transmitter transmits the first distribution information, and otherwise, the transmitter transmits the second distribution information. The number of visits is a number of pieces of identification information in which the installation areas are identical to one another and the pieces of terminal information match one another.

According to the present disclosure, it is possible to efficiently provide information suitable for users with their privacy ensured.

### BRIEF DESCRIPTION OF DRAWINGS

FIG. 1 illustrates a configuration of a display control system in an exemplary embodiment;

FIG. 2 is a functional block diagram of a signage server in the display control system in the exemplary embodiment;

FIG. 3 schematically illustrates an area DB in the display control system in the exemplary embodiment;

FIG. 4 schematically illustrates a users' visiting DB in the display control system in the exemplary embodiment;

FIG. 5 is a flowchart of an operation of an information update unit in the display control system in the exemplary embodiment; and

FIG. 6 is a flowchart of an operation of a locality degree calculation unit in the display control system in the exemplary embodiment.

### DETAILED DESCRIPTION

An exemplary embodiment will be described in detailed below with reference to the drawings as appropriate. It should be noted that in some cases, needlessly detailed descriptions will not be given. For example, technical matters known in the art will not be described in detail, or configurations that are substantially the same as those stated previously will not be described. This is for the purpose of preventing description from being redundant and helping understanding of those skilled in the art.

Descriptions that will be given below and the accompanying drawings should be used to help those skilled in the art to fully understand the present disclosure and are not intended to limit the subject matters in the claims.

An exemplary embodiment of the present disclosure will be described below with reference to the drawings.

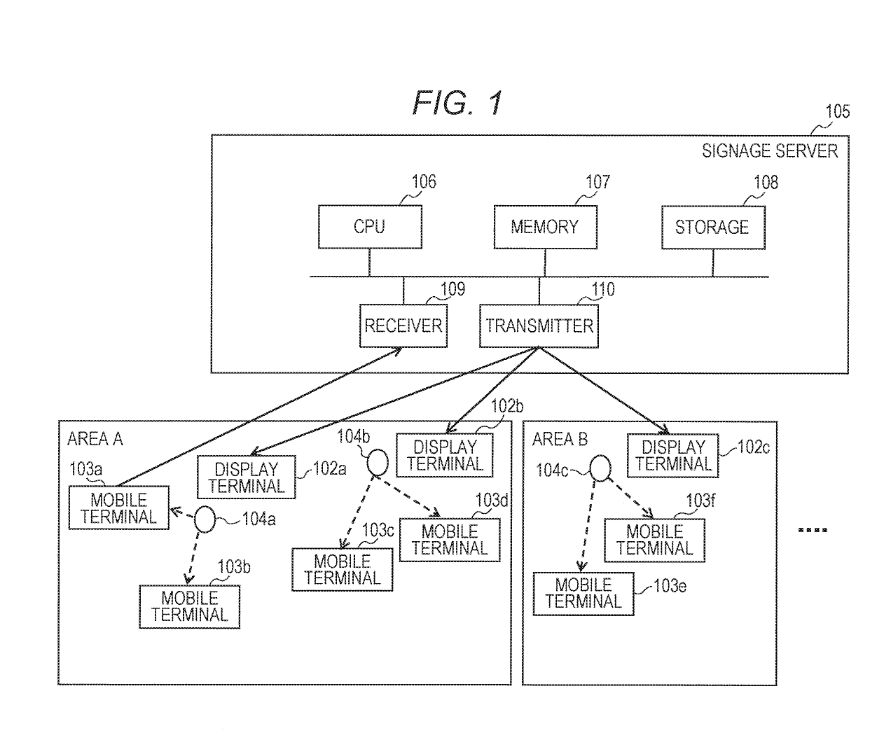

A description will be given of a display control system having a display control device in this exemplary embodiment, with reference to FIG. 1. FIG. 1 illustrates a configuration of the display control system in the exemplary embodiment

The display control system includes display terminals 102a to 102c, mobile terminals 103a to 103f, beacons 104a to 104c, and signage server 105. The plurality of display terminals 102a to 102e are installed in a plurality of areas, including area A and area B. Mobile terminals 103a to 103f are possessed by users at corresponding locations. Beacon 104a is disposed close to display terminal 102a and issues a signal for measuring respective distances between display terminal 102a and mobile terminals 103a and 103b. Beacon 104b is disposed close to display terminal 102b and issues a signal for measuring respective distances between display terminal 102b and mobile terminals 103c and. 103d. Beacon 104c is disposed close to display terminal 102c and issues a signal for measuring respective distances between display terminal 102c and mobile terminals 103e and 103f. Signage server 105 distributes, via a network, content suitable for area A to display terminals 102a and 102b and content suitable for region B to display terminal 102c.

Beacons 104a to 104c continuously issue signals containing their identifications (beacon IDs) to be used for beacon identification. Mobile terminals 103a and 103b are each equipped in advance with an application that receives a signal from beacon 104a and measures intensity (radio field intensity) of the signal. Mobile terminals 103c and 103d are each equipped in advance with an application that receives a signal from beacon 104b and measures radio field intensity of the signal. Mobile terminals 103e and 103f are each equipped in advance with an application that receives a signal from beacon 104c and measures radio field intensity of the signal. If radio field intensity of a received signal containing a beacon ID is greater than certain intensity, each application determines that a user is close to a corresponding display terminal, and then reports, as identification information, the beacon ID and a mobile terminal ID for identifying mobile terminals 103a to 103f to signage server 105 via the network.

When mobile terminals 103a and 103b receive a signal from beacon 104a, if radio field intensity of this signal is greater than predetermined intensity, mobile terminals 103a and 103b report information regarding the radio field intensity of the received signal to signage server 105 at regular time intervals. When mobile terminals 103c and 103d receive a signal from beacon 104b, if radio field intensity of this signal is greater than predetermined intensity, mobile terminals 103c and 103d report information regarding the radio field intensity of the received signal to signage server 105 at regular time intervals. When mobile terminals 103e and 103f receive a signal from beacon 104c, if radio field intensity of this signal is greater than predetermined intensity, mobile terminals 103e and 103f report information regarding the radio field intensity of the received signal to signage server 105 at regular time intervals. It should be noted that all mobile terminals 103a to 103f can communicate with signage server 105 via the network, although only communication between mobile terminal 103a and signage server 105 is illustrated in FIG. 1.

Beacons 104a to 104c are installed to determine which area a user is located. Instead of beacons 104a to 104c, for example, a GPS may be used to pinpoint a current location of a user. Alternatively, images displayed by display terminals 102a to 102c may be acquired, and an area in which a user is located may be determined based on the acquired images.

Each pair of display terminal and beacon may be integrally formed.

Mobile terminals 103a and 103b do not have to directly transmit information regarding a distance to display terminal 102a to signage server 105. Alternatively, mobile terminals 103a and 103b may transmit the information via display terminal 102a or another terminal. Mobile terminals 103c and 103d do not have to directly transmit information regarding a distance to display terminal 102b to signage server 105. Alternatively, mobile terminals 103c and 103d may transmit the information via display terminal 102b or another terminal. Mobile terminals 103e and 103f do not have to directly transmit information regarding a distance to display terminal 102c to signage server 105. Alternatively, mobile terminals 103e and 103f may transmit the information via display terminal 102c or another terminal.

Signage server 105 includes central processing unit (CPU) 106, memory 107, storage 108, receiver 109, and transmitter 110. Receiver 109 receives information regarding beacon IDs, radio field intensity, and mobile terminal IDs, which is transmitted from mobile terminals 103a to 103f at regular time intervals. Transmitter 110 transmits contents to be displayed to display terminals 102a to 102c.

Referring to FIG. 1, display terminals 102a, 102b are disposed in area A, and beacons 104a, 104b are also disposed in area A in relation to display terminal 102a, 102b. Display terminal 102c and beacon 104c are disposed in area B. Each of mobile terminals 103a to 103f is displaced to area A or B or to some other area when the user moves, and receives a signal from a corresponding beacon.

Beacons 104a to 104c and display terminals 102a to 102c do not necessarily have a one-to-one relationship. Alternatively, at least one beacon may be disposed in one area.

Since display terminals 102a to 102c have the same configuration, an arbitrary one of display terminals 102a to 102c will be referred to below as a display terminal. Since mobile terminals 103a to 103f have the same configuration, an arbitrary one of mobile terminals 103a to 103f will be referred to below as a mobile terminal. Since beacons 104a to 104c have the same configuration, an arbitrary one of beacons 104a to 104c will be referred to below as a beacon.

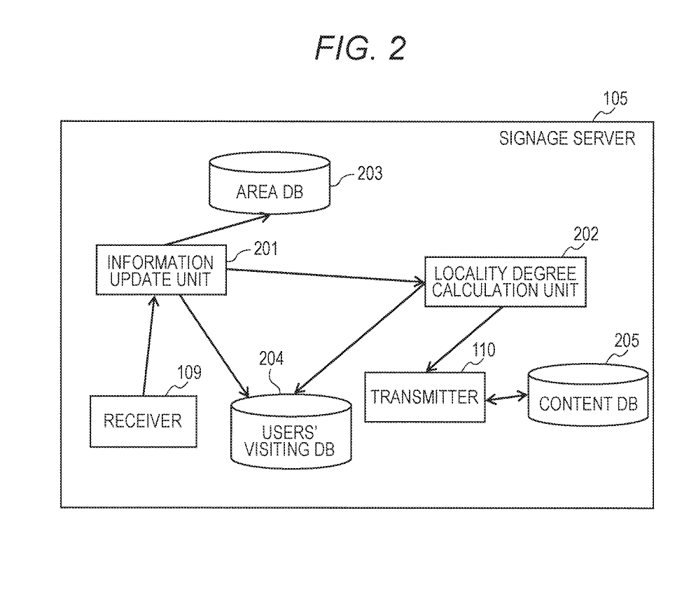

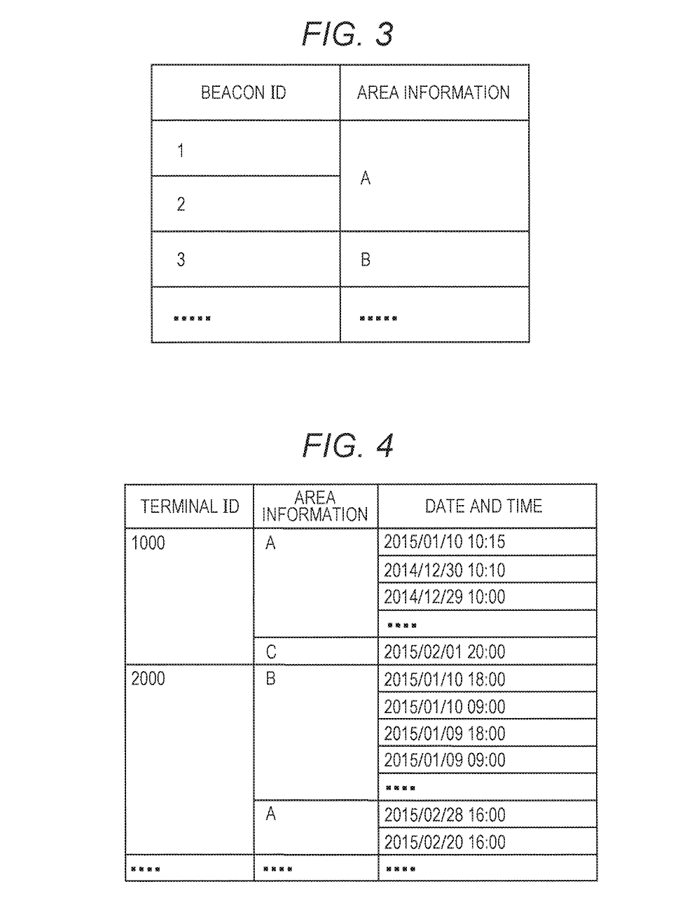

Next, a functional block of signage server 105 will be described with reference to FIG. 2 to FIG. 4. FIG. 2 is a functional block diagram of signage server 105 in the display control system in the exemplary embodiment. FIG. 3 schematically illustrates an area DB in the display control system. FIG. 4 schematically illustrates a users' visiting DB in the display control system.

Signage server 105 includes information update unit 201, locality degree calculation unit 202, area DB 203, users' visiting DB 204, content DB 205, receiver 109, and transmitter 110.

The term, “locality degree” in the exemplary embodiment refers to an index used to discriminate between a local person and a tourist. This locality degree is reflected in content displayed by the display terminal.

In area DB 203, as illustrated in FIG. 3, beacons ID are associated with area information in advance. Thus, at least one beacon and at least one display terminal are disposed in one area.

In users' visiting DB 204, as illustrated in FIG. 4, mobile terminal IDs, and dates and times when the users visited each area are listed. For example, it can be seen that the user having the mobile terminal with the mobile terminal ID No. 1000 visited area A three times between 29th Dec. 2014 and 10th Jan. 2015. Furthermore, this user also visited area C once.

In content DB 205, contents for tourists (first distribution information) and contents for local persons (second distribution information) are stored in each of the areas.

Information update unit 201 refers to identification information received by receiver 109 and area DB, and then updates users' visiting DB 204. When determining that a user is close to the display terminal based on radio field intensity, for example, the information update unit 201 instructs locality degree calculation unit 202 to update content together with information on the user close to the display terminal, namely, the mobile terminal ID.

Locality degree calculation unit 202 refers to the instruction from information update unit 201 or users' visiting DB 204 at predetermined timing and calculates a locality degree. Then, locality degree calculation unit 202 reports, to transmitter 110, the locality degree and information for identifying the display terminal that will display updated content.

Transmitter 110 receives the locality degree and the information for identifying the display terminal received from locality degree calculation unit 202 and then transmits, to a specific display terminal, the received locality degree and information as well as associated content, that is, content for tourists or local persons.

Information update unit 201 and locality degree calculation unit 202 may be implemented by CPU 106 and, memory 107 described above. Area DB 203, users' visiting DB 204, and content DB 205 are stored in storage 108.

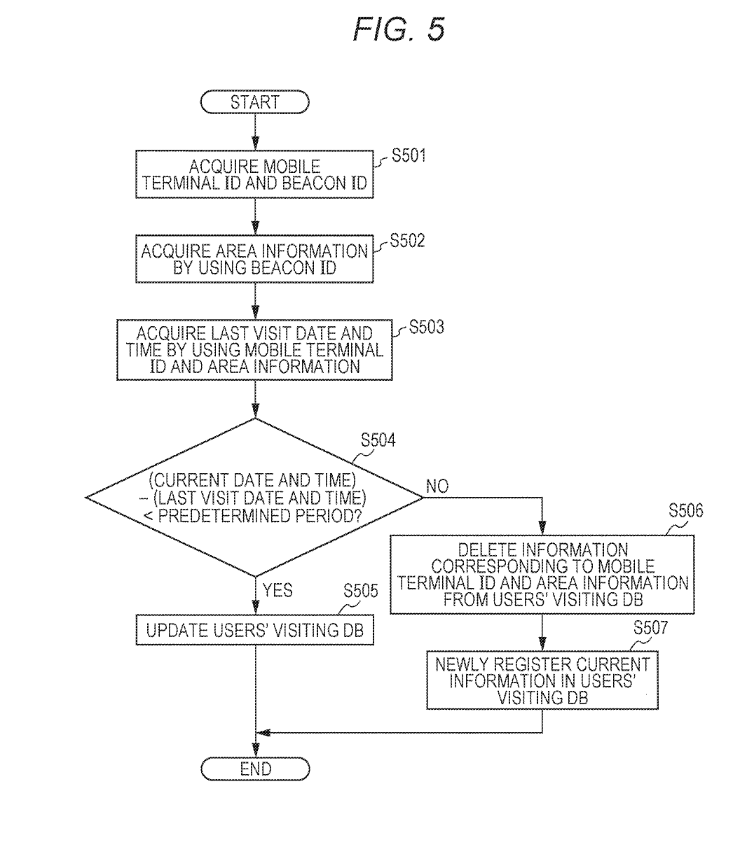

A description will be given of an operation of information update unit 201 in signage server 105 configured as above, with reference to FIG. 5. FIG. 5 is a flowchart of an operation of information update unit 201 in the display control system in the exemplary embodiment.

First, in Step S501, information update unit 201 acquires identification information, i.e., a mobile terminal ID and a beacon ID, which is received by receiver 109.

In Step S502, information update unit 201 searches area DB 203 by using the acquired beacon ID, and acquires information regarding the area where the user is located.

In Step S503, information update unit 201 then searches users' visiting DB 204 by using the mobile terminal ID acquired in Step S501 and the area information acquired in Step S502, and acquires the date and time of the user's last visit.

In Step S504, information update unit 201 determines a temporal difference between the current date and time and the date and time of the user's last visit, and determines whether the resultant temporal difference is shorter than a predetermined period. In this case, the current date and time may be a transmission date and time when the mobile terminal transmits its the information or a reception time when signage server 105 receives the information.

If the temporal difference is shorter than a predetermined, period, in Step S505, information update unit 201 updates the information, acquired in Step S501 and Step S502 by adding the current information (mobile terminal ID, area information, and current date and time) to users' visiting DB 204.

If the temporal difference is equal to or longer than the predetermined period, in Step S506, information update unit 201 deletes entire information corresponding to the mobile terminal ID acquired in Step S501 and the area information acquired in Step S502 from users' visiting DB 204. Then, in Step S507, information update unit 201 newly registers the current information (mobile terminal ID, area information, and current date and time) in users' visiting DB 204.

As described above, information update unit 201 deletes data from users' visiting DB 204, if a predetermined period has passed since the last visit. This enables locality degree calculation unit 202 to calculate a locality degree more easily.

For example, in a case where a tourist visits a certain area only once in six months, but the number of visits increases with time. In this case, if a locality degree is calculated based on only the number of visits, locality degree calculation unit 202 may erroneously determine that the user is not a tourist. To avoid this disadvantage, information update unit 201 deletes information corresponding to the mobile terminal ID and the area information, as described above.

The predetermined period in Step S504 may be any given period. For example, to prevent a tourist who visits once in six months as described above from being determined as a local person, the predetermined period may be set as five month and the information may be then deleted from users' visiting DB. That is, if the temporal difference between the current date and time and the last visit date and time is six months and the predetermined period is set to five months, it is determined as No in Step S504, and the process proceeds to Step S506. Then, in Step S506, information update unit 201 deletes information corresponding to the mobile terminal ID and the area information.

Alternatively, information update unit 201 may not determine whether the temporal difference between the current date and time and the last visit date and time is shorter than the predetermined period in Step S504. In this case, in Step S505, information update unit 201 may update the information acquired in Step S501 and Step S502. For example, the user's first visit to area A is made on 1st Jan. 2014, the second visit on 1st Oct. 2014, the third visit on 1st Jan. 2015, and the fourth visit on 1st Oct. 2015. In this case, every time the user visits area A, in Step S505, information update unit 201 may update the information acquired in Step S501 and Step S502.

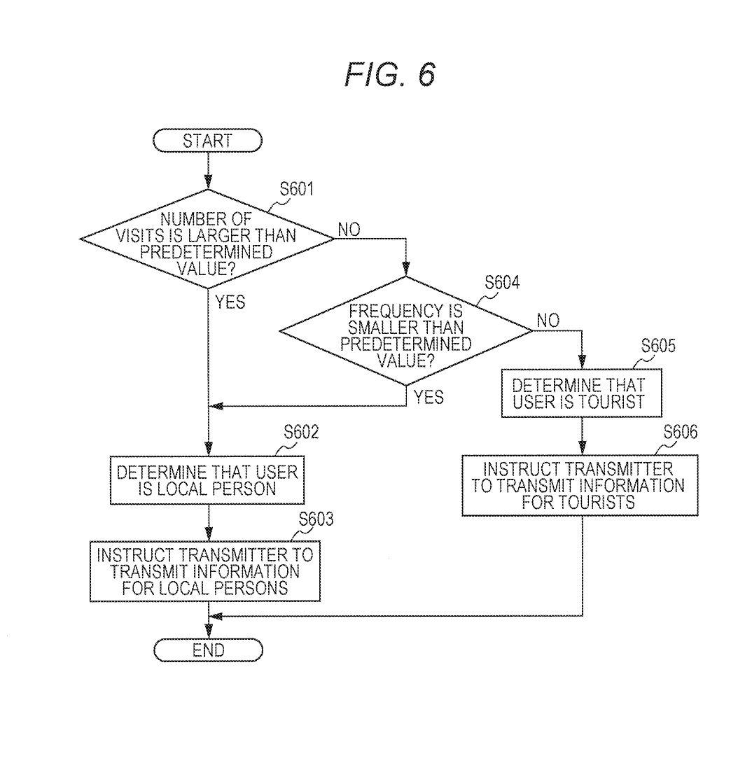

Next, an operation of locality degree calculation unit 202 will be described with reference to FIG. 6. FIG. 6 is a flowchart of an operation of locality degree calculation unit 202 in the display control system in the exemplary embodiment.

Locality degree calculation unit 202 identifies a mobile terminal ID by using an instruction from information update unit 201 or by using some other method. Then, locality degree calculation unit 202 acquires a current location (area information) of the identified mobile terminal ID from users' visiting DB 204. Locality degree calculation unit 202 searches users' visiting DB 204 by using both the mobile terminal ID and the area information, and counts the number of visits. In Step S601, locality degree calculation unit 202 checks whether the number of visits is larger than a predetermined value.

If the number of visits is larger than the predetermined value, in Step S602, locality degree calculation unit 202 determines that the user is a local person. Then, in Step S603, locality degree calculation unit 202 instructs transmitter 110 to transmit information on content for local persons.

If the number of visits is equal to or less than the predetermined value, locality ee calculation unit 202 calculates a visit frequency. The visit frequency represents how often a user has visited, a certain area and can be obtained by ((the last visit date and time)−(the first visit date and time))/(the number of visits) in users' visiting DB 204. In Step S604, locality degree calculation unit 202 checks whether the frequency calculated in this manner is smaller than a predetermined value.

If the visit frequency is smaller than the predetermined value, in Step S602, locality degree calculation unit 202 determines that the user is a local person. Then, in Step S603, locality degree calculation unit 202 instructs transmitter 110 to transmit information on content for local persons. If the frequency is equal to or larger than the predetermined value, in Step S605, locality degree calculation unit 202 determines that the user is a tourist. Then, in Step S606, locality degree calculation unit 202 instructs transmitter 110 to transmit information on content for tourists.

For example, the user's first visit to area A is made on 1st Jan. 2014, the second visit on 1st Oct. 2014, the third visit on 1st Jan. 2015, and the fourth visit on 1st Oct. 2015. In this case, the number of visits is smaller than a predetermined value (five times), and the visit frequency is larger than a predetermined value (once in five months). Therefore, it is determined as No in Step S601 and No in Step S604, and the user is determined as a tourist in Step S605.

In this exemplary embodiment, the mobile terminal transmits a beacon ID, and the information update unit determines which area a user is located in, based on the beacon ID. Thus, the beacon ID is transmitted as area information. However, the mobile terminal may directly transmit area information.

If two pieces of data have similar dates and times, the mobile terminal, information update unit 201, or locality degree calculation unit 202 may ignore or delete one piece of data. In this exemplary embodiment, locality degree calculation unit 202 counts the number of visits by using radio field intensity. Therefore, it is possible to reduce the risk that locality degree unit may count the number of visits redundantly while a user stays within a predetermined area for a certain period.

As described above, a display control device that corresponds to signage server 105 in this exemplary embodiment is to be connected to a display device that corresponds to a display terminal and a mobile terminal. This display control device includes receiver 109 that receives identification information; the identification information contains terminal information for identifying the mobile terminal and area information for identifying installation areas of the display device. The display control device further includes a storage unit and a transmitter 110. The storage unit corresponds to memory 107 that stores the identification information together with a transmission date and time or a reception date and time. Transmitter 110 transmits first distribution information or second distribution information to the display device, based on the identification information. When the number of visits is smaller than a predetermined number and an interval between the dates and times in a plurality of pieces of the identification information is longer than a predetermined interval or when the installation areas are identical to one another and the number of visits is one, transmitter 110 transmits the first distribution information, and otherwise, transmitter 110 transmits the second distribution information. The number of visits is a number of pieces of identification information in which the installation areas are identical to one another and the pieces of terminal information match one another.

The display control device configured as above can discriminate between a person with a high visit frequency and a person with a low visit frequency by using not only the number of visits but also visit dates and times. As described above, the display control device identifies whether a visitor is a local person or a tourist, thereby efficiently providing information to a user.

When a temporal difference between a date and time in the received identification information and a date and time in previous identification information is longer than a predetermined period, the identification information may be deleted. This enables locality degree calculation unit 202 to calculate a locality degree easily.

A display control system in this exemplary embodiment includes; the display control device that corresponds to signage server 105; the display device; the mobile terminal; and a beacon that measures a distance between the display device and the mobile terminal. The display control system discriminates between a local person and a tourist, thereby efficiently providing information, to a user.

The display control device and the display control system identify a user by using only information regarding users visits. Therefore, it is not necessary to use personal information, such as an address.

According to the present disclosure, a display control device and a display control system are applicable to, for example, digital signage installed at stations arid the like.

What is claimed is:

1. A display control device to be connected to a display device and a mobile terminal, the display control device comprising:
a receiver that receives identification information, the identification information containing terminal information for identifying the mobile terminal and area information for identifying an installation area of the display device;
a storage unit that stores the identification information together with a transmission date and time or a reception date and time; and
a transmitter that transmits first distribution information or second distribution information to the display device, based on the identification information,
wherein when a number of visits is smaller than a predetermined number and an average interval between dates and times in a plurality of pieces of the identification information is longer than a predetermined interval or when a plurality of the installation areas are identical to one another and the number of visits is one, the transmitter transmits the first distribution information, and otherwise, the transmitter transmits the second distribution information, and
the number of visits is a number of pieces of identification information in which the installation areas are identical to one another and the pieces of terminal information match one another.

2. The display control device according to claim 1, wherein
when a temporal difference between a date and time in the received identification information and a date and time in previous identification information is longer than a predetermined period, the identification information is deleted.

3. A display control system comprising:
the display control device according to claim 1;
the display device;
the mobile terminal; and
a beacon that measures a distance between the display device and the mobile terminal.
